(19) United States
(12) Patent Application Publication
(10) Pub. No.: US 2014/0048513 A1
(43) Pub. Date: Feb. 20, 2014

(54) CIRCUIT BREAKER

(71) Applicant: FUJI ELECTRIC FA COMPONENTS & SYSTEMS CO., LTD., Tokyo (JP)

(72) Inventors: Yutaka SATO, Kounosu-shi (JP); Akifumi SATO, Kounosu-shi (JP)

(21) Appl. No.: 13/933,748

(22) Filed: Jul. 2, 2013

(30) Foreign Application Priority Data
Aug. 14, 2012 (JP) 2012-179681

(51) Int. Cl. H01H 33/06

(52) U.S. Cl. CPC H01H 33/06
USPC 218/117

(57) ABSTRACT

It is possible to extend an arc as far as an arc extinguishing chamber without increasing an opening distance of a movable contact, and to increase an arc voltage, thus improving the breaking performance, without changing a switching mechanism or increasing a size of the external form of a circuit breaker. A circuit breaker includes a breaking portion having a fixed contact and movable contact, and an arc extinguishing chamber disposed so as to enclose the breaking portion. An insulating arm made of an insulator is provided to be capable of advancing into and withdrawing from the space between contact points of the fixed contact and movable contact. Further, the insulating arm advances to a position between the contact points when the movable contact carries out an opening operation, and withdraws from the space between the contact points when the movable contact carries out a closing operation.

### BACKGROUND OF THE INVENTION

1. Technical Field

The present invention relates to a circuit breaker such as a wiring breaker or earth leakage circuit breaker used in a low voltage circuit, and in particular, relates to technology for driving an arc to grids of an arc extinguishing chamber, thereby extinguishing the arc in a short time, at a time of current-limiting breaking.

2. Related Art

A circuit breaker including a breaking portion having a fixed contact and movable contact and an arc extinguishing chamber disposed so as to enclose the breaking portion is known as this kind of circuit breaker. The arc extinguishing chamber includes a supporting body made of an insulator, and a plurality of grids supported in a layer form by the supporting body. The fixed contact is fixed to a main body case, and has a fixed contact point on one end thereof and a terminal formed on the other end. Meanwhile, the movable contact has on one end thereof a movable contact point that contacts the fixed contact point, while the other end is turnably coupled to a movable contact holder made of an insulator and turnably supported by the main body case. Further, the movable contact is urged toward the fixed contact by a contact pressure spring fitted between the movable contact and the movable contact holder.

This kind of circuit breaker is such that, when breaking a short-circuit current, an arc is generated between the fixed contact point and movable contact point. The arc is drawn into the grids disposed in the arc extinguishing chamber, split up, and cooled, whereby the arc voltage is increased, and the arc is extinguished. Herein, technology whereby a magnetic flux is generated by a magnetic body being disposed in the vicinity of the contact points, and the arc is driven in the direction of the grids by electromagnetic force (for example, refer to JP-A-2011-129385 and JP-A-2005-216807), and technology whereby the arc is driven by the pressure of gas generated when breaking (for example, refer to JP-A-9-7487 and JP-A-8-227648), have been disclosed as heretofore known technology.

However, in order to improve breaking performance in this kind of circuit breaker, it is necessary to increase the distance between the contact points when the movable contact opens, thereby increasing the arc voltage. However, as there is a restriction on the height direction dimension of the breaking portion in a structure wherein the height direction dimension of the circuit breaker is reduced, it is necessary to adopt other methods. In particular, when the absolute value of the short-circuit current is small, or when breaking a direct current, the electromagnetic force does not work sufficiently on the arc in the direction of the grids. Because of this, there is a problem in that the arc stops on the contact points, leading to contact point erosion or a drop in insulating performance.

Also, when causing gas to be generated when breaking, and utilizing the pressure thereof as an arc driving force, there is a problem in that the pressure inside the housing increases when an arc is generated. Because of this, it is necessary to ensure large thickness of the housing and select a high-strength material, and it is necessary to secure a large arc space on the power source side, meaning that problems remain with regard to product specifications and cost.

### SUMMARY OF THE INVENTION

Therefore, the invention, having been contrived on these kinds of problem, has an object of providing a circuit breaker wherein it is possible to extend an arc as far as an arc extinguishing chamber without increasing the opening distance of a movable contact, and to increase the arc voltage, thus improving the breaking performance, without changing in a switching mechanism or increasing in size of the external form of the circuit breaker.

In order to solve the heretofore described problems, a circuit breaker according to one aspect of the invention includes a breaking portion having a fixed contact and a movable contact, and an arc extinguishing chamber for extinguishing an arc generated between contact points of the fixed contact and movable contact. Further, the circuit breaker according to the one aspect of the invention includes an insulating arm made of an insulator provided so as to be capable of advancing into and withdrawing from the space between the contact points of the fixed contact and movable contact. The insulating arm advances to the position between the contact points when the movable contact performs an opening operation. Also, the insulating arm withdraws and moves away from the space between the contact points when the movable contact performs a closing operation.

Herein, in the circuit breaker according to the one aspect of the invention, it is preferable that the fixed contact is fixed to a main body case, and has a fixed contact point on one end thereof and a terminal formed on the other end. Also, it is preferable that the movable contact has on one end thereof a movable contact point that contacts the fixed contact point. Furthermore, it is preferable that the other end of the movable contact is turnably coupled to a movable contact holder made of an insulator and turnably supported by the main body case. Furthermore, it is preferable that the movable contact is urged toward the fixed contact by a contact pressure spring fitted between the movable contact and the movable contact holder.

Furthermore, in the circuit breaker according to the one aspect of the invention, it is preferable that the insulating arm is such that a base end portion thereof is mounted in the movable contact holder. Further, it is preferable that the insulating arm advances or withdraws in tandem with an opening or closing operation of the movable contact by turning integrally with the movable contact holder.

According to the circuit breaker according to the one aspect of the invention, the insulating arm made of an insulator is provided so as to be able to advance into and withdraw from the space between the contact points of the fixed contact and movable contact. Further, as the insulating arm is positioned between the contact points when the movable contact opens, an arc generated between the contact points is driven farther to the arc extinguishing chamber side than the contact points, and it is thus possible to increase the expansion distance of the arc. Also, as the insulating arm is inserted between the contact points only when the contact points are opened, while the insulating arm is withdrawn when the contact points are in a closed condition, the current-carrying performance of the contact points is not impaired.

Therefore, the arc is swiftly driven to the grids, and it is thus possible to obtain a circuit breaker with excellent current limiting performance, even in a breaker whose dimension in the height direction of the circuit breaker is reduced. That is, according to the circuit breaker according to the one aspect of the invention, it is possible to extend an arc as far as the arc extinguishing chamber without increasing the opening distance of the movable contact, and it is possible to increase the arc voltage, thus improving the breaking performance, with no accompanying change in the switching mechanism or increase in size of the external form of the circuit breaker.

As heretofore described, according to the invention, it is possible to extend an arc as far as an arc extinguishing chamber without increasing the opening distance of a movable contact, and it is possible to increase the arc voltage, thus improving the breaking performance, with no accompanying change in a switching mechanism or increase in size of the external form of the circuit breaker.

### BRIEF DESCRIPTION OF THE DRAWINGS

FIG. 1 is an overall structural view (a longitudinal sectional view in a central pole portion) of a circuit breaker according to an embodiment of the invention;

FIG. 2 is a perspective view (a rear face portion) of a movable contact holder portion of FIG. 1;

FIG. 3 is a perspective view (a front face portion) of the movable contact holder portion of FIG. 1;

FIG. 4 is an exploded perspective view of a main portion of a movable contact of FIG. 1;

FIGS. 5A and 5B are illustrations of a main portion of the circuit breaker of FIG. 1, wherein FIG. 5A shows contact points in a closed condition, while FIG. 5B shows the contact points in an opened condition; and

FIG. 6 is an illustration of a main portion of the circuit breaker of the embodiment of the invention (a diagram showing an image of an arc generation condition at a time of a short-circuit breaking).

### DETAILED DESCRIPTION OF THE EMBODIMENTS

Hereafter, a description will be given of an embodiment of the invention, while referring as appropriate to the drawings.

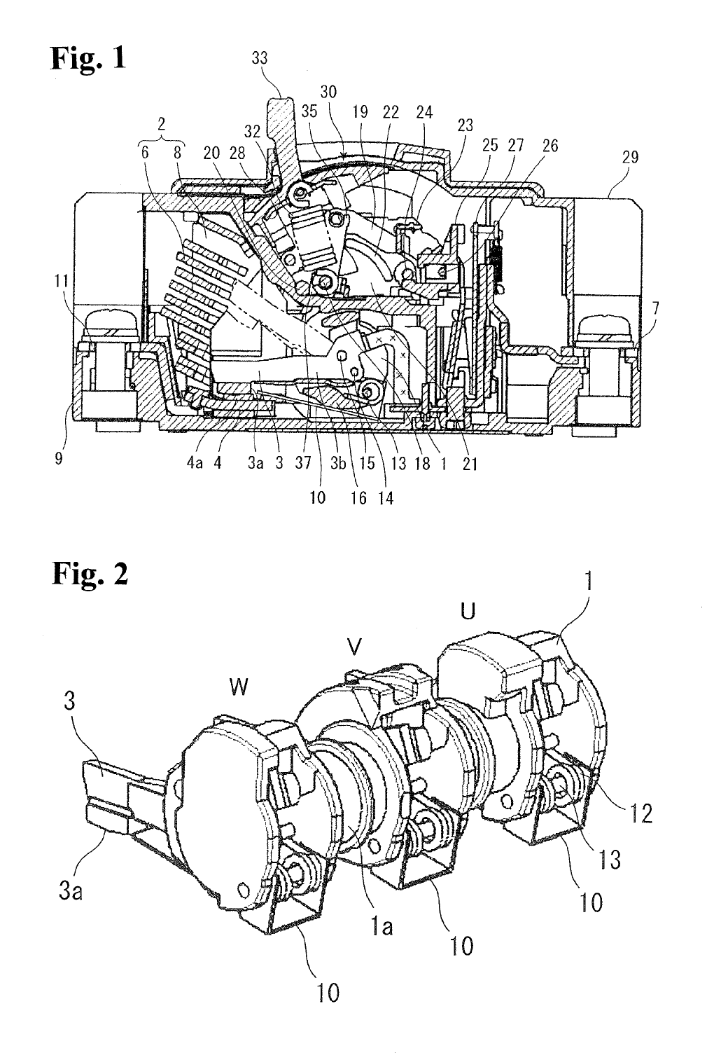

FIG. 1 is a longitudinal sectional view in a central pole portion of a three-pole circuit breaker. As shown in FIG. 1, the circuit breaker includes an insulating receptacle formed of a main body case 9 made of molded resin and a cover 29 covering the main body case 9 from above. FIG. 1 shows the central pole portion, but the interior of the main body case 9 is divided by inter-phase dividing walls into three phase spaces, corresponding one each to U, V, and W phases, and phase breaking portions having the same configuration are housed one in each of the spaces.

A power source side terminal 11 and a load side terminal 7 are provided for each of the U, V, and W phases on either side of the main body case 9. A fixed contact 4 is fixed to the leading end of the power source side terminal 11. A fixed contact point 4a is provided on the leading end of the fixed contact 4. Meanwhile, a movable contact 3 driven so as to open or close by a switching mechanism 30 is connected via an overcurrent tripping device 27 to the load side terminal 7. A movable contact point 3a is provided on the leading end of the movable contact 3. The movable contact point 3a is disposed so as to face the fixed contact point 4a. The breaking portion is configured of the fixed contact 4 and movable contact 3. An arc extinguishing chamber 2 is disposed between the power source side terminal 11 and breaking portion so as to enclose the breaking portion along the contact opening movement path of the movable contact 3. The arc extinguishing chamber 2 includes a supporting body 8 made of an insulator, and a plurality of grids 6 supported in layer form by the supporting body 8.

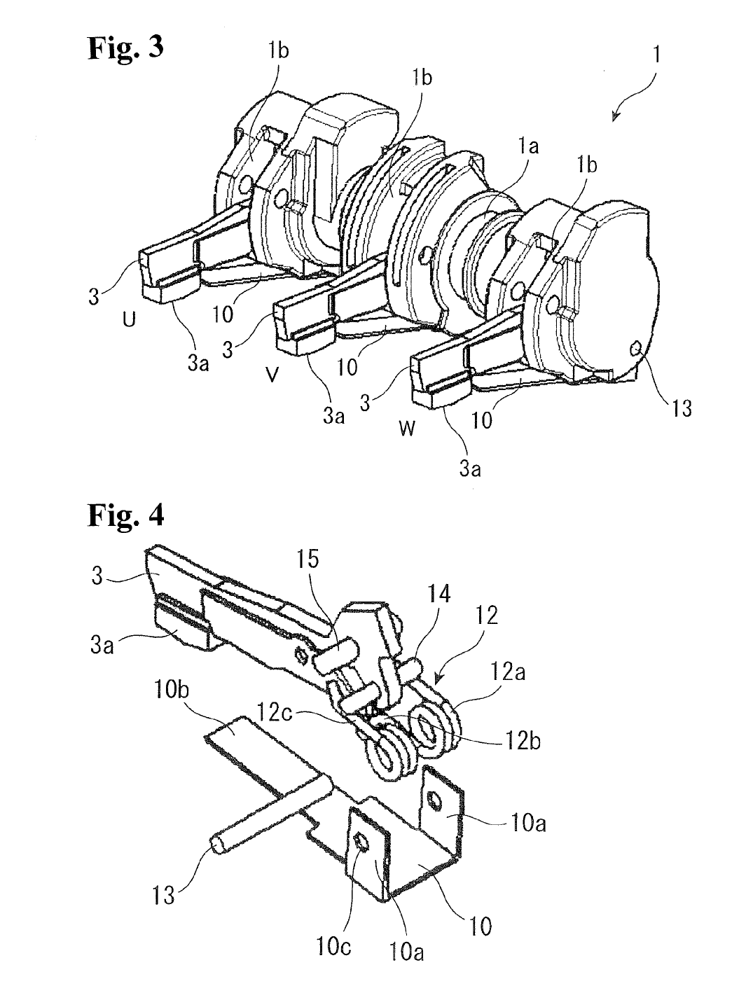

FIGS. 2 and 3 show perspective views of a movable contact holder portion of FIG. 1. The movable contact 3 is supported by a turnable movable contact holder 1. The movable contact 3 is such that an opening or closing operation of the movable contact 3 is carried out in the three phases simultaneously in conjunction with an operation of the switching mechanism 30 and an opening operation of the contact point when breaking. Specifically, a base end portion of the movable contact 3 in the three poles corresponding one each to the U, V, and W phases is supported by the movable contact holder 1, made of an insulator (made of a molded resin), corresponding to each phase. The movable contact holders 1 are disposed inside the main body case 9, in a condition wherein they are coupled to each other via a pivot shaft portion 1a, so as to be turnable with respect to the main body case 9 (refer to FIG. 1). A contact holding groove 1b for each pole is formed in the turning direction in the movable contact holder 1. The movable contact 3 is turnably supported by a supporting shaft 15 in the contact holding groove 1b, as shown in FIG. 1. The supporting shaft 15 is inserted through a shaft hole bored through the base portion of the movable contact 3, and both ends of the supporting shaft 15 are fixed to the movable contact holder 1.

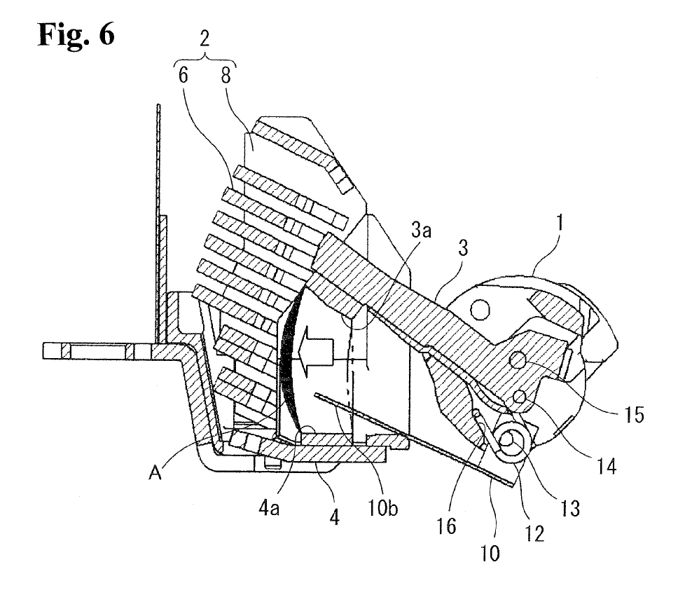

As shown in FIG. 4, a coupling pin 13, a supporting pin 14, and a contact pressure spring 12 are provided below the supporting shaft 15. The contact pressure spring 12 is formed of a double torsion spring structure formed of left and right coil portions 12a, a coupling portion 12b stretched between the left and right coil portions 12a, and hook portions 12c at either end of the coil portions. The coupling pin 13 is inserted inside the left and right coil portions 12a, and the left and right hook portions 12c sandwich the movable contact 3 from the left and right. The leading end of the coupling portion 12b is engaged on a lower portion of the supporting pin 14 provided on the movable contact holder 1 side. Also, the hook portions 12c at either end are latched onto a supporting portion 16 provided on a lower portion of the movable contact holder 1 (refer to FIG. 6). Because of this, the contact pressure spring 12 urges the movable contact 3 toward the fixed contact 4.

Returning to FIG. 1, the circuit breaker includes the switching mechanism 30, which causes an opening or closing operation of the movable contact 3 to be performed. The switching mechanism 30 is supported via a side plate 21 by the main body case 9, and can drive the movable contact 3 so as to open or close, with the pivot shaft portion 1a (refer to FIGS. 2 and 3) integrated with the movable contact holder 1 as a fulcrum.

Furthermore, a tripping mechanism that trips a locking of the switching mechanism 30, and the overcurrent tripping device 27, which detects an overcurrent and causes the tripping mechanism to operate, are provided in the circuit breaker. The overcurrent tripping device 27, based on the result of detecting an overcurrent flowing via the load side terminal 7, generates a mechanical deflection using a thermomotive method or electromagnetic method, and the tripping mechanism can trip a locking of the switching mechanism 30 by transmitting the mechanical deflection generated by the overcurrent tripping device 27 to the switching mechanism 30 via a trip crossbar 25.

Also, the switching mechanism 30 includes a toggle mechanism and an opening/closing spring 32. The toggle mechanism includes a first link 35 and second link 37, which are coupled to each other via a toggle pin 18. The upper end of the first link 35 is coupled to a latch 19, and the second link 37 is coupled to the movable contact holder 1. The latch 19 is turnably supported with a latch rotating shaft 20 as a fulcrum.

The latch 19 is provided so that it can be engaged with a latch holder 23. The latch holder 23 is configured so as to be turnable around a latch holder rotating shaft 24, and is configured so that it can be engaged with the trip crossbar 25. The trip crossbar 25 is turnable around a crossbar rotating shaft 26. A lower end hook portion of the opening/closing spring 32 is hooked onto the toggle pin 18. An upper end hook portion of the opening/closing spring 32 is hooked onto the upper end of a handle lever 28. The handle lever 28 is swingably supported with the lever shaft as a fulcrum, and has its center of rotation on the side plate 21. The handle lever 28 is assembled so as be interlocked with an opening/closing handle 33.

A link stopper 22 is provided on the side plate 21. The link stopper 22 stops the toggle mechanism in a predetermined position by contacting with the toggle pin 18. The switching mechanism 30 inverts the direction of action with respect to the opening/closing spring 32 in response to an opening or closing operation of the handle lever 28, thereby driving the movable contact holder 1 so as to open or close. Furthermore, the action of the opening/closing spring 32 with respect to the toggle mechanism is inverted by the latch 19 being disengaged in response to an opening or closing operation of the handle lever 28, because of which the movable contact holder 1 can be driven so as to open or close.

Because of this, the circuit breaker is such that the handle bar 28 interlocked with the opening/closing handle 33 is driven, and the toggle mechanism that operates in response to the opening/closing spring 32 is driven, in response to an opening or closing operation of the opening/closing handle 33 in the left-right direction. Further, by the movable contact 3 coupled to the movable contact holder 1 turning together with the movable contact holder 1, the movable contact point 3a is capable of contacting with or separating from the fixed contact point 4a of the fixed contact 4, whereby a closing or opening operation is performed.

When the movable contact 3 is in the closed position, the contact pressure spring 12 presses the movable contact point 3a against the fixed contact point 4a of the fixed contact 4, thus applying contact pressure between the contact points. Meanwhile, when an opening operation is carried out, the movable contact holder 1 in each pole turns in a clockwise direction around the pivot shaft portion 1a in response to a tripping operation of the switching mechanism 30, driving the movable contact 3 mounted in the movable contact holder 1 so as to move away toward the opened position.

Herein, as shown in the drawings, the circuit breaker is such that an insulating arm 10, provided so as to be able to advance into and withdraw from the space between the fixed contact point 4a of the fixed contact 4 and the movable contact point 3a of the movable contact 3, is mounted on the lower surface side of the movable contact 3. The insulating arm 10 of the embodiment is such that a base end portion thereof is supported together with the contact pressure spring 12 by the movable contact holder 1, as shown in FIG. 4. The insulating arm 10 is made of an insulator processed into sheet metal, and includes an arm portion 10b, extended along an arm portion 3b of the movable contact 3, and a pair of coupling portions 10a formed in a squared C shape on a base end portion of the arm portion 10b. A through hole 10c through which the coupling pin 13 can be inserted is formed in the pair of coupling portions 10a.

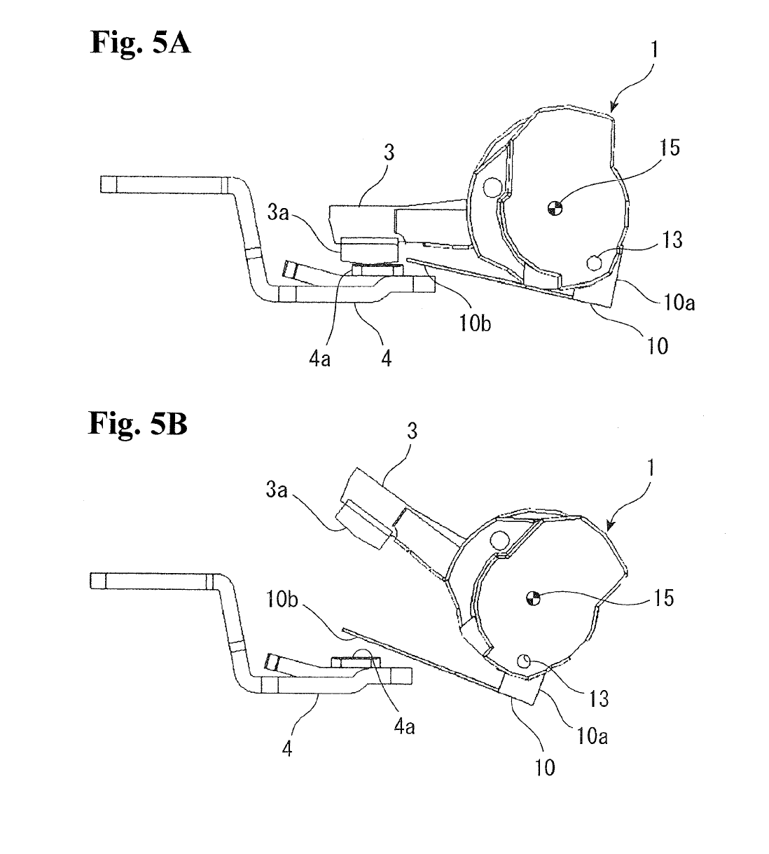

The pair of coupling portions 10a is configured so as to cover the lower portion of the arm portion 3b of the movable contact 3 from both sides, and mounted so as to straddle the base portion of each movable contact 3. Because of this, the insulating arm 10, by turning integrally with each movable contact 3, advances or withdraws in tandem with an opening or closing operation of the movable contact 3 (refer to FIGS. 5A and 5B). That is, FIGS. 5A and 5B show the disposition of the insulating arm 10 when the movable contact holder 1 performs an opening or closing operation, wherein the insulating arm 10 is such that the arm portion 10b advances to the contact point side to position between the contact points, when the movable contact 3 performs an opening operation, as shown in FIG. 5B. Meanwhile, when the movable contact 3 performs a closing operation, the arm portion 10b withdraws and moves away from between the contact points, as shown in FIG. 5A.

Next, a description will be given of an operation and effect of the circuit breaker.

The insulating arm 10 made of an insulator is provided so as to be able to advance into and withdraw from the space between the fixed contact point 4a of the fixed contact 4 and the movable contact point 3a of the movable contact 3 in the circuit breaker of the embodiment. Further, the insulating arm 10 is such that, when the movable contact 3 opens, the arm portion 10b of the insulating arm 10 advances in tandem with an opening operation of the movable contact holder 1, and the leading end of the arm portion 10b is positioned between the movable contact point 3a and fixed contact point 4a, as shown in FIG. 5B.

Because of this, according to the circuit breaker, when the contact points are in an “opened” condition, the leading end of the arm portion 10b of the insulating arm 10 is disposed above the fixed contact point from the side opposite to that of the arc extinguishing chamber 2 when the movable contact 3 opens, because of which an arc A generated between the contact points is driven farther to the arc extinguishing chamber 2 side than the contact points, as shown in FIG. 6 by the image of the arc A generation condition at a time of a short-circuit breaking. Because of this, the arc A is extended in the direction of the grids 6, and the arc A is drawn into the grids 6 disposed in the arc extinguishing chamber 2. Because of this, the arc voltage increases, and the arc is extinguished. Consequently, according to the circuit breaker, it is possible to increase the expansion distance of the arc A, because of which the arc A can be expanded to the arc extinguishing chamber 2 without increasing the opening distance of the movable contact 3. Because of this, in the case of the circuit breaker, it is possible to increase the arc voltage, thus improving the breaking performance, with no accompanying change in the switching mechanism 30 or increase in size of the external form of the circuit breaker, even in a breaker whose dimension in the height direction of the circuit breaker is reduced. Also, the arc A is swiftly driven to the grids 6, and it is thus possible to obtain a circuit breaker with excellent current limiting performance.

Also, according to the circuit breaker, the arm portion 10b of the insulating arm 10 withdraws in tandem with a closing operation of the movable contact holder 1 when the movable contact 3 closes, and the leading end of the arm portion 10b moves away from between the movable contact point 3a and fixed contact point 4a, as shown in FIG. 5A. That is, the circuit breaker is such that the insulating arm 10 is inserted between the contact points only when the contact points are opened, while the insulating arm 10 is withdrawn when the contact points are in a closed condition. Because of this, according to the circuit breaker, the insulating arm 10 is withdrawn from the contact points when the contact points are in a “closed” condition, meaning that the current-carrying performance of the contact points is not impaired.

As heretofore described, according to the circuit breaker, it is possible to extend the arc A as far as the arc extinguishing chamber 2 without increasing the opening distance of the movable contact 3, and to increase the arc voltage, thus improving the breaking performance, with no accompanying change in the switching mechanism or increase in size of the external form of the circuit breaker.

The circuit breaker according to the invention not being limited to the heretofore described embodiment, various modifications are possible provided that they do not depart from the scope of the invention.

For example, in the heretofore described embodiment, the insulating arm 10 has been described using an example wherein the base end portion thereof is mounted in the movable contact holder 1, and the insulating arm 10 advances or withdraws in tandem with an opening or closing operation of the movable contact 3 by turning integrally with the movable contact holder 1, but the embodiment is not limited to this. That is, provided that the insulating arm according to the invention is provided so as to be able to advance into and withdraw from the space between the contact points of the fixed contact and movable contact, and that the configuration of the insulating arm is such that it advances, and is positioned between the contact points, when the movable contact performs an opening operation, and withdraws and moves away from between the contact points when the movable contact performs a closing operation, various aspects thereof can be employed.

However, when the configuration of the circuit breaker is such that a fixed contact is fixed to a main body case, and has a fixed contact point on one end thereof and a terminal formed on the other end, a movable contact has on one end thereof a movable contact point that contacts the fixed contact point, while the other end is turnably coupled to a movable contact holder made of an insulator and turnably supported by the main body case, and the movable contact is urged toward the fixed contact by a contact pressure spring fitted between the movable contact and the movable contact holder, it is preferable that the insulating arm is configured so that the base end portion thereof is mounted in the movable contact holder, and the insulating arm advances or withdraws in tandem with an opening or closing operation of the movable contact by turning integrally with the movable contact holder.

### DESCRIPTION OF REFERENCE NUMERALS

1 movable contact holder
2 arc extinguish chamber
3 movable contact
3a movable contact point
4 fixed contact
4a fixed contact point
9 main body case
10 insulating arm
12 contact pressure spring

What is claimed is:

1. A circuit breaker, comprising:
a breaking portion including a fixed contact and a movable contact;
an arc extinguishing chamber for extinguishing an arc generated between contact points of the fixed contact and the movable contact; and
an insulating arm made of an insulator provided to be capable of advancing into and withdrawing from a space between the contact points of the fixed contact and the movable contact,
wherein the insulating arm is structured to advance to a position between the contact points when the movable contact performs an opening operation, and to withdraw to move away from the space between the contact points when the movable contact performs a closing operation.

2. A circuit breaker according to claim 1, wherein the fixed contact is fixed to a main body case, and comprises a fixed contact point on one end and a terminal formed on another end,
the movable contact comprises a movable contact point to contact the fixed contact point on one end thereof, and another end is rotatably coupled to a movable contact holder made of an insulator and rotatably supported by the main body case, and is urged toward the fixed contact by a contact pressure spring fitted between the movable contact and the movable contact holder, and
the insulating arm has a base end portion mounted in the movable contact holder, and rotates integrally with the movable contact holder to advance or withdraw in tandem with the opening or closing operation of the movable contact.

3. A circuit breaker according to claim 1, further comprising:
a main body case,
a movable contact holder made of an insulator and rotatably supported by the main body case, and
a contact pressure spring fitted between the movable contact and the movable contact holder,
wherein the movable contact comprises a movable contact point to contact a fixed contact point on one end thereof, and another end rotatably coupled to the movable contact holder and urged toward the fixed contact by the contact pressure spring, and
the insulating arm has a base end portion mounted in the movable contact holder, and rotates integrally with the movable contact holder to advance or withdraw along with the opening or closing operation of the movable contact.
